(19) United States
(12) Patent Application Publication
(10) Pub. No.: US 2018/0112809 A1
(43) Pub. Date: Apr. 26, 2018

(54) APPARATUS AND METHOD FOR FLUID REMOVAL FROM A PIPELINE

(71) Applicant: John Anderson, Hawthorne, WI (US)

(72) Inventor: John Anderson, Hawthorne, WI (US)

(21) Appl. No.: 15/789,129

(22) Filed: Oct. 20, 2017

Related U.S. Application Data
(60) Provisional application No. 62/410,940, filed on Oct. 21, 2016.

(51) Int. Cl. F16L 41/06; F16L 41/16

(52) U.S. Cl. CPC F16L 41/06; F16L 41/16

(57) ABSTRACT

The disclosure of the invention provides apparatus, assembly kits, and methods for removing fluid from a pipeline. The apparatus has a receptacle member defined by a wall with a first opening that conforms to an outer surface of a pipeline, a second opening in the wall that allows fluid to exit the receptacle, and a drill or saw attached to a shaft movable through a third opening in the wall. The first opening can be placed up against the surface of a pipeline to form a fluidically tight seal, and the saw or drill can be moved and rotated to cut a hole in the pipeline. Fluid can be removed from the pipeline through the receptacle and second opening. The apparatus can be attached to elongate members that extend around the circumference of a pipeline, and a connecting member can be actuated to pull connecting members toward each other to tighten the components and force the receptacle member up against the pipeline.

### CROSS-REFERENCE TO RELATED APPLICATION

The present non-provisional application claims the benefit of commonly owned provisional application having Ser. No. 62/410,940, filed Oct. 21, 2016, entitled “APPARATUS AND METHOD FOR FLUID REMOVAL FROM A PIPELINE”, which application is incorporated herein by reference in its entirety.

### FIELD OF INVENTION

The invention is directed to pipeline maintenance and repair equipment and associated methods.

### BACKGROUND

Pipeline maintenance can be a difficult and expensive operation. Maintenance can include cleaning and removal of section of the pipeline. Often, sections of pipeline need repair which requires that any fluid in the pipeline, such as oil or a petroleum product, be removed from within the pipeline before the repair process takes place. This can require access to the inside of the pipeline, which can be a challenging and laborious process.

In some cases a tapping operation is used to remove fluid from the pipeline. In this operation a fitting having a flange is welded to the pipeline at a location where the tap is to be made. The fitting can extend radially from the pipeline. After the fitting with flange is attached, a tapping valve can be attached to the flange and a tapping machine can then be mounted on the tapping valve. After the tapping operation is complete, the tapping machine can be removed from the tapping valve and replaced with a plugging machine to provide a non-permanent plug which blocks flow of material being transported through the pipeline so that maintenance can be performed on or within the pipeline. Following maintenance, the non-permanent plug can be withdrawn from the pipeline and replaced with a permanent plug which is positioned in the fitting. To complete the operation, a blind flange is connected to the flanged fitting on the pipeline.

### SUMMARY

The invention provides an apparatus and method that facilitates the safe and efficient removal of a fluid from a pipeline. The apparatus can be temporarily mounted on a pipeline with relative ease, and then the pipeline can be bored into using the apparatus of the invention to provide access to the inside of the pipeline and the fluid therein. Fluid can then be removed from the pipeline through the apparatus of the invention.

In one aspect, the invention provides an apparatus for cutting and removing fluid from a pipeline, wherein the apparatus is configured to be temporarily placed on and forced up against an external surface the pipeline. The apparatus includes a receptacle configured to accommodate fluid being withdrawn from the pipeline through a hole made in the pipeline by the apparatus, and also configured to facilitate fluid movement out of the receptacle. The receptacle is formed from at least one wall defining the receptacle member. The receptacle has a first opening on a pipeline-facing portion of the receptacle and a rim defining the first opening, the rim having a shape that conforms to a portion of an outer surface of the pipeline. The rim can form a fluidically tight seal with an outer surface of the pipeline when the receptacle member is forced up against the pipeline surface. The receptacle also includes a second opening through the receptacle wall, which serves as a fluid exit aperture from the receptacle. The receptacle also includes a third opening through a receptacle wall, through which a shaft is slidably disposed. The apparatus also includes a drill or saw disposed within the receptacle which is rotatable, and which can be actuated to cause cutting of the pipeline. The drill or saw is radially movable towards and away from the pipeline wall. The shaft is slidably disposed through the third opening and is attached to the drill or saw. The shaft is rotatable and slidably movable in a radial direction within the third opening of the receptacle. The first opening of the apparatus can be larger than the second or third opening.

The invention also provides an assembly kit for removing fluid from a pipeline which includes the cutting and fluid removal apparatus described herein. The assembly kit also includes one or more elongate members that can be attached to the cutting and fluid removal apparatus that can extend partially or fully around the circumference of a pipeline. The assembly kit also includes a connecting member attachable to the one or more elongate members which can be actuated to affect their movement and force the cutting and fluid removal apparatus up against the outer surface of a pipeline.

The invention also provides a method for removing fluid from a pipeline. The method uses an apparatus for removing fluid from a pipeline comprising a receptacle member defined by at least one wall, the receptacle comprising a first opening that conforms to an outer surface of a pipeline, a second opening in the at least one wall that allows fluid to exit the receptacle, and a drill or saw attached to a shaft movable through a third opening in the at least one wall. The opening of the receptacle is placed up against the surface of a pipeline to form a fluidically tight seal. The shaft and attached saw or drill is moved in a radial direction towards the pipeline and a hole is cut in the pipeline by rotating the shaft and attached saw or drill. Fluid is then removed from the pipeline through the receptacle and second opening.

### BRIEF DESCRIPTION OF DRAWINGS

FIG. 1 is a side perspective view of a cutting/fluid removal apparatus mounted on a portion of a pipeline using a mounting apparatus.

FIG. 2 is a cross-sectional side view of a cutting/fluid removal apparatus mounted on a portion of a pipeline using a mounting apparatus.

FIG. 3 is a perspective view of a back wall of a cutting/fluid removal apparatus.

FIG. 4 is a perspective view of a receptacle member (shown in isolation) of a cutting/fluid removal apparatus.

FIG. 5 is an cross-sectional illustration a receptacle member of a cutting/fluid removal apparatus showing exemplary dimensions.

FIG. 6 is a cross-sectional view of a portion of a receptacle wall with pipeline-facing rim and gasket within a recess of the rim.

FIG. 7 is a cross-sectional side view of the receptacle and hole saw of a cutting/fluid removal apparatus.

FIG. 8 is a perspective view of a cutting/fluid removal apparatus mounted on a portion of a pipeline using a mounting apparatus.

FIG. 9 is a perspective view of a portion of a cutting/fluid removal apparatus attached to an elongate member.

FIG. 10 is a perspective view of a portion of a mounting apparatus for the cutting/fluid removal apparatus showing a connecting member attached to ends of elongate members.

FIG. 11 is a cross-sectional side view of the connecting member attached to ends of elongate members.

### DETAILED DESCRIPTION

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

Generally, the disclosure describes an apparatus for removing fluid from a pipeline. One embodiment of the disclosure is an apparatus which can be temporarily mounted on the outer surface of a pipeline. For example, in a temporary mount the apparatus is not welded to the pipeline. The apparatus is able to cut into a portion of pipeline and remove fluid from the pipeline (herein referred to as a “pipe cutting/fluid removal apparatus”). This pipe cutting/fluid removal apparatus can be used in conjunction with another apparatus that facilitates the temporary mounting of the fluid removal apparatus on the pipeline (a “mounting apparatus”). Embodiments of the invention therefore are directed to the pipe cutting/fluid removal apparatus, and methods of using, the mounting apparatus and methods of using, as well as the combination of the pipe cutting/fluid removal apparatus and mounting apparatus and methods of using.

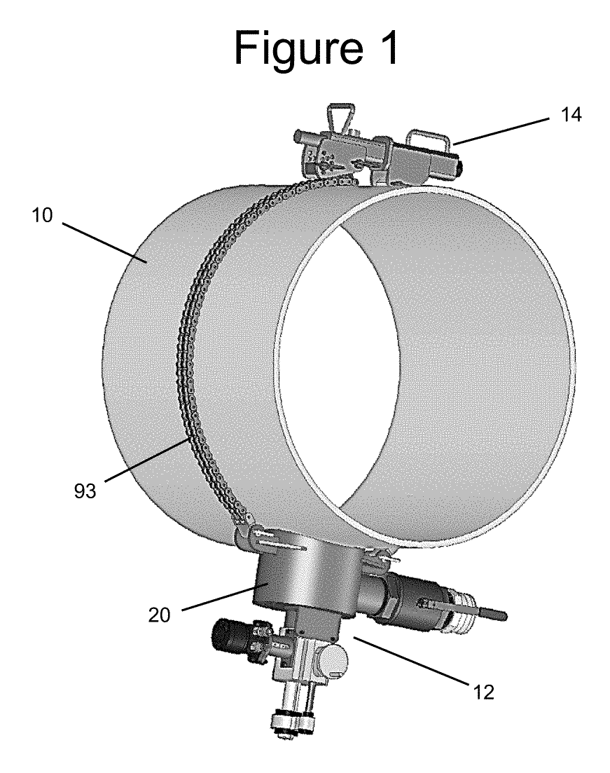

With reference to FIG. 1, and in an exemplary embodiment, shown is a section of pipe 10, the pipe cutting/fluid removal apparatus 12, and the mounting apparatus 14 for the pipe cutting/fluid removal apparatus 12. The pipe-facing portion of the pipe cutting/fluid removal apparatus 12 is shown as placed up against a lower section of the section of pipe 10.

In order to explain aspects of the pipe cutting/fluid removal apparatus, the mounting apparatus, and use in conjunction with a pipeline, terms “upper,” “lower,” “below,” and “above” can be used to indicate the position of components or features of the apparatus when it is in a working arrangement. A “working arrangement” can be when the pipe cutting/fluid removal apparatus is attached to a portion of the pipeline (e.g., attached to the lower wall of a pipeline). For example, in methods of the disclosure such as using a cutting/fluid removal apparatus as shown in FIG. 1, the part of the pipe cutting/fluid removal apparatus attached to the pipeline will reflect the “upper” portion(s) of the pipe cutting/fluid removal apparatus in a working arrangement. Similarity, the terms “above” or “below” may also be used to indicate the position of components or features of the cutting/fluid removal apparatus in relation to one another, when the pipe cutting/fluid removal apparatus is in a working arrangement. In methods of the disclosure, the terms “vertical,” and “horizontal,” and “level” may also be used to indicate the position of components or features of the pipe cutting/fluid removal apparatus when it is in a working arrangement. For example, a component of the apparatus that is in a “horizontal” position is parallel with the horizon, and one in a “vertical” position is one perpendicular with the horizon. Further, terms such as “proximal” and “distal” can be used to describe the positional relationship of apparatus of the disclosure, or parts thereof, such as the mounting apparatus and pipe cutting/fluid removal apparatus, or parts thereof, relative to the pipeline. For example, in a working arrangement, features of the apparatus that are closer to the pipeline's center may be referred to proximal, whereas those further from the pipeline's center may be referred to distal. The terms such as “proximal” and “distal” can also be used to describe the positional relationship of one feature of the apparatus in relation to another feature of the same apparatus, or an associated apparatus.

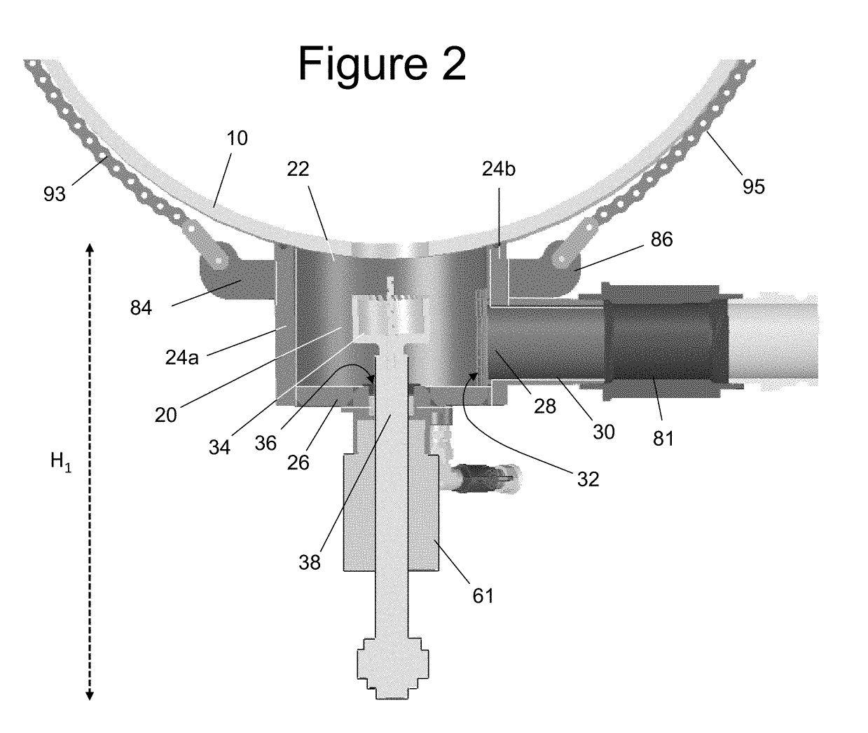

Referring back to FIG. 1, the drilling/fluid collection apparatus 12 includes a receptacle 20, which is a portion of the apparatus that collects fluid (such as oil) as it is removed from the pipe. With reference to FIG. 2, the drilling/fluid collection apparatus 12 and internal components thereof are show in greater detail in a cross-sectional view. A portion of the receptacle 20 forms an opening 22 (e.g., a first opening) that faces the surface of the pipe in a working arrangement. The receptacle 20 includes a side wall (portions of the side wall 24a, 24b are shown) and a back wall 26. The apparatus comprises an opening for the removal of fluid that is in the receptacle which includes an exit port 28 (e.g., a second opening) in the side wall 24b and a conduit 30 attached to and extending perpendicularly away from the side wall 24b.

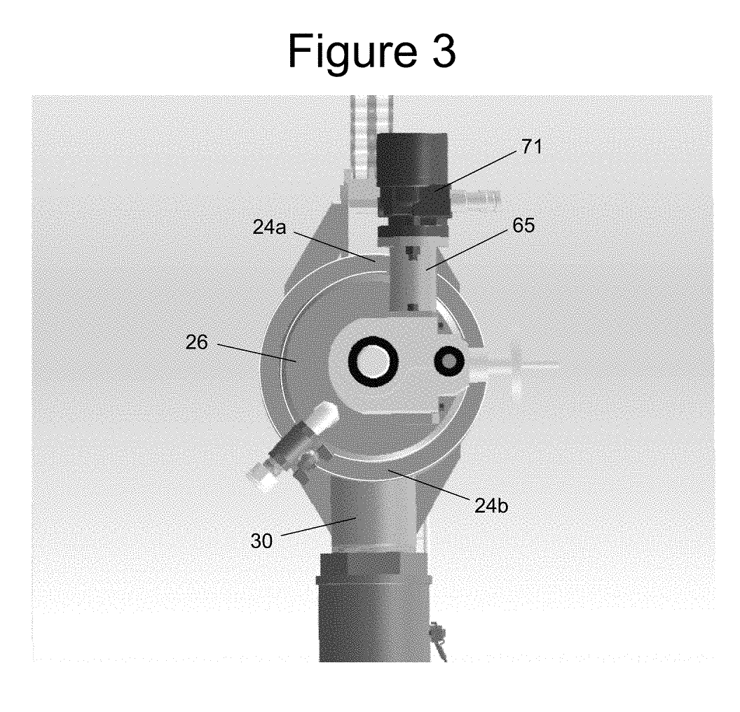

In some embodiments, the side wall has a continuous arcuate shape, such as where it curved back upon itself (e.g. circular or oval). See, for example, FIG. 3, which is a view of the drilling/fluid collection apparatus from its back wall side wall 26 showing that side wall 24 (portions of the side wall 24a, 24b) is circular when viewed from this perspective. In this regard, a side wall with a continuous arcuate shape (e.g., circular, providing the receptacle with a cylindrical shape) can be considered a single side wall.

The side wall of the receptacle with a circular shape can be fabricated from a portion of a pipe. For example, a pipe of a desired diameter can be used to make the sidewall, wherein one end of the pipe is cut to provide an arcuate shape that conforms to a portion of the outer surface of the pipeline that the drilling/fluid collection apparatus is to be attached to.

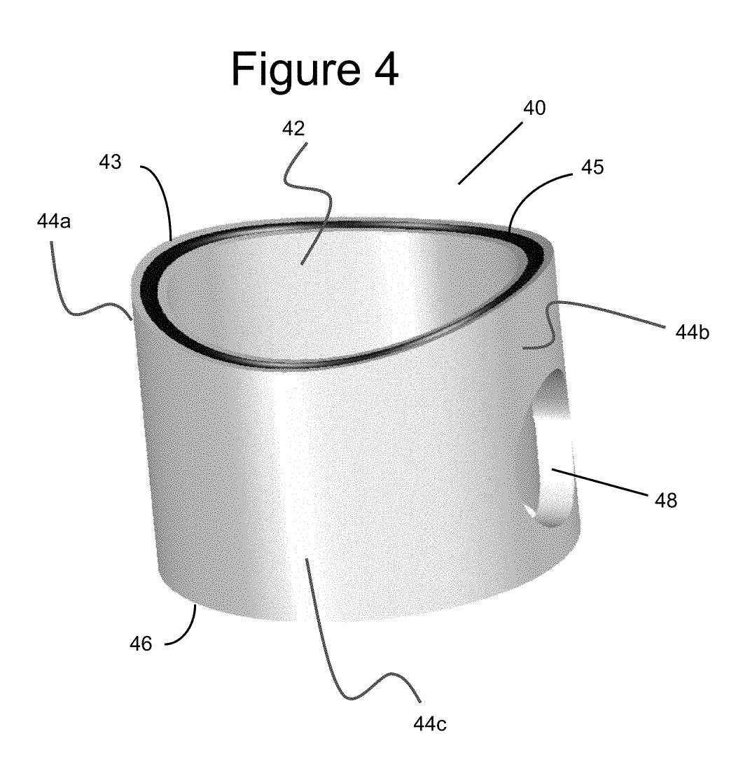

With reference to FIG. 4, the receptacle 40 part of the drilling/fluid collection apparatus is shown in isolation from other components of the apparatus. The pipe-facing portion (proximal end of the receptacle 40) has an opening 42 (e.g., a first opening) at least as large as the diameter of the hole saw within the receptacle (see, e.g., FIG. 2, hole saw 34). The pipe-facing portion is also configured to conform (mate) to a portion of the outer surface of a pipeline. This configuration can be achieved by fabricating the pipe-facing portion according to the known dimensions of the pipeline the apparatus is intended to be used in conjunction with. Accordingly, the outer diameter of the pipeline to which the apparatus is attached can provide basis for the shape of the cut that is made on the pipe-facing portion of the receptacle 40. Receptacles with openings of desired sizes and shapes can be constructed based on common pipeline diameters.

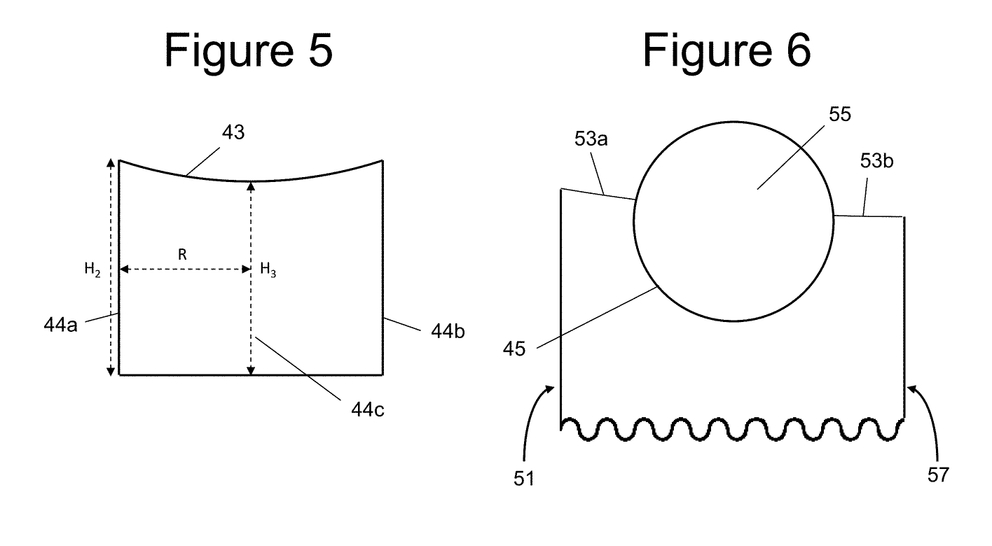

FIG. 5 is cross sectional diagram illustrating dimensional aspects of the receptacle, which includes the pipe-facing portion having a concave shape. With reference to both FIGS. 4 and 5, the concavity provides a configuration wherein the wall portions 44A and 44B, opposite from one another, have a greater (first) height than a (second) height of wall portions 44C and 44D (not shown), also opposite from one another and which are between wall portions 44A and 44B. Referring to FIG. 5, the difference between the first height (H₂) and the second height (H₃) relative to the radius of the receptacle (R) correlates to the outer diameter of the portion of the pipeline the pipeline-facing portion of the receptacle is configured to conform to.

Also referring to FIG. 4, in embodiments, the pipe-facing portion of the receptacle 40 is defined by a rim 43 corresponding to the circumference of the receptacle and having a thickness corresponding to the wall of the receptacle. The rim 43 can include a recess 45 in its surface. The recess 45 can accommodate a gasket (not shown in FIG. 4) useful for forming a fluidically tight seal between the receptacle and the pipeline when the rim is forced up against the outer surface of the pipeline. The recess 45 can have any suitable shape such as partially-circular or partially-oval (e.g., semi-circular), or other, depending on the type of gasket used. In exemplary embodiments, the recess fits a gasket having a diameter in the range of about ⅛^{th} inch to about 1 inch, such as about ½ inch.

FIG. 6 is a cross sectional illustration of a portion of the receptacle wall with its outer surface 51 and inner surface 57. FIG. 6 also shows outer circumferential surface rim 53a and inner circumferential surface rim 53b. Between the outer and inner circumferential surfaces is the recess 45 that accommodates gasket 55.

Referring back to FIG. 2, the receptacle 20 also includes an exit port 28 which fluid is moved though after it enters the receptacle from the pipeline. The exit port 28 can be any desired shape or size, although it is preferably sized to permit a desired (e.g., higher) volume of flow of the liquid out of the receptacle. Referring to FIG. 4, the exit port can be formed from an opening 48 (e.g., a second opening) in the sidewall portion 44b of the receptacle 40. Referring back to FIG. 2, the exit port 28 can be any desired shape or size, although it is preferably sized to permit a desired (e.g., higher) volume of flow of the liquid out of the receptacle. The exit port 28 can have an opening of at least the same size as the opening that is made in the pipeline using the hole saw (i.e., the diameter of exit port 28 is equal or greater to the diameter of hole saw 34). For example, the exit port can have an opening of a size of at least about 1 in² to about 30 in², or about 3.5 in² to about 20 in². The exit port 28 may also be associated with a grate 32 over the opening in the sidewall. The grate 32 can prevent objects that may become present in fluid within the receptacle, such as a piece of the pipeline that is cut using the hole saw, from entering the flow of fluid away from the receptacle, which may otherwise clog the tube that carries fluid away from the receptacle.

Instead of the side wall being a circular shape (e.g., as shown in FIGS. 1, 3, 4, etc.), alternatively, the receptacle may have more than one side wall with flat or a non-arcuate shape(s). For example, receptacle can have a square, rectangular, polyogonal, or even a combination or arcuate and straight shapes when the side wall of the receptacle is viewed from the open side or the back side.

The side wall of the receptacle can be of a predetermined thickness, such as in the range of about 0.05 inches (˜1.25 mm) to about 2 inches (˜51 mm), or about 0.075 inches (˜2 mm) to about 1.25 inch (˜32 mm). In embodiments the sidewall can be uniform in thickness around its circumference. The receptacle is preferably durable and able to withstand pressures applied to the wall when the pipeline-facing rim is forced up against the outer surface of the pipeline. The side wall of the receptacle can be made of a material compatible with the fluid, such as oil, that is drained from the pipeline. Exemplary materials that can be used to construction the receptacle include stainless steel, carbon steel, alloy steel, aluminum, or other suitable material, such as hard plastic materials such as poly(vinylchloride) (PVC) and acrylic. Other components of the apparatus as described herein can be made from these same durable materials.

The receptacle can optionally be described in terms of its internal volume. For example, the internal volume of the receptacle can be in the range of about 100 in³ (˜1.64 L) to about 2500 in³ (˜41 L), about 200 in³ (˜3.25 L) to about 1500 in³ (˜24.6 L), or about 250 in³ (˜4.1 L) to about 1000 in³ (˜16.4 L). The hole saw and shaft can occupy volume and in turn reduce the overall volume of the receptacle.

With reference to FIG. 2, the receptacle 20 also includes a back wall 26. The back wall 26 is shown as substantially flat, but could be any suitable shape, including those that curve outward. The back wall 26 can include an opening 36 (e.g., third opening) through which shaft 38 that is connected to hole saw 34 is slidably disposed.

While embodiments of the invention provide a receptacle with a cylindrical or substantially cylindrical shape, the receptacle can optionally be of another shape. For example, an alternative shape for the receptacle is a bowl-like shape. In this regard, the receptacle may have a single “wall” defined by a curved and continuous surface having openings to provide a pipeline-facing surface, an exit port, and for the shaft.

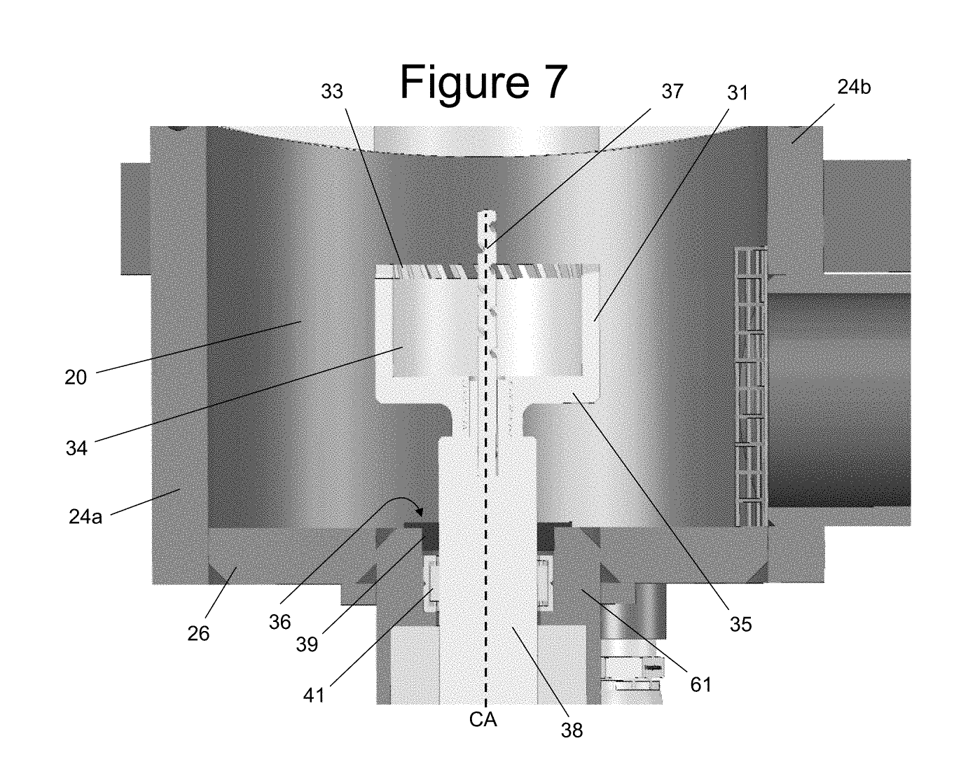

As described herein and shown in FIGS. 2 and 7, the apparatus also includes a saw or drill within the receptacle. The saw or drill can cut or bore a desired opening in the pipeline for removal of fluid from the interior of the pipeline. In one embodiment, FIG. 7 is an enlarged portion of FIG. 2 and illustrates the receptacle 20 and components therein in greater detail. The apparatus includes a hole saw 34 which is disposed and movable within the receptacle 20 and attached to shaft 38. The shaft 38 is rotatable along its rotational axis (CA), which accordingly causes rotation of the hole saw 34, and the hole saw is also movable in proximal (towards the pipeline surface) and distal (away from the pipeline surface) directions within the receptacle. A hole saw refers to an article having a cylindrical shape, typically made of a hardened material such as a metal alloy, having teeth 33 at one end that, when rotated, can bore a circular hole in a substrate. The hole saw 34 can have a cylindrical shape with a base 35 proximal to and parallel with the back wall of the receptacle and side walls parallel with the receptacle side walls. In some embodiments the base 35 of the hole saw is in a plane parallel to the back wall of the receptacle. The hole saw 34 can be defined by a central axis (CA, shown as a dotted line) in the center of cylinder of the hole saw 34 about which the hole saw 34 rotates. The hole saw 34 can include one or more hardened materials, such a graphite, tungsten carbide, diamond, etc. on the saw teeth 33 to facilitate cutting. An exemplary diameter of the hole saw 34 is in the range of about 1 inch to about 6 inches, or about 2 inches to about 5 inches. The hole saw 34 can be rotated about its central axis CA to cut a hole within the wall of the pipeline.

A drill bit 37 can be centered and aligned with the central axis CA of the hole saw 34. The drill bit 37 can be connected to the center of the proximal portion (the base 35) of the hole saw 34, which in turn can be connected to shaft 38. Rotational movement of the shaft 38 will cause rotational movement of the hole saw 34 and the drill bit 37. The distal end of the drill bit 37 (i.e., towards the opening of the receptacle 20) can extend distally beyond the teeth 37 of the circular cutting edge of the hole saw 34. That is, in use, when the hole saw 34 is advanced towards the wall of the pipeline to be cut, the drill bit 37 will contact and bore into the pipeline before the teeth 37 of the circular cutting edge of the hole saw 34 begins cutting. Entry of the distal end of the drill bit 37 into the pipeline wall can stabilize the hole saw 34 as it cuts into the pipeline wall.

In addition to rotational movement, the hole saw 34 can be configured to move within the receptacle 20 radially inwards and radially outwards (i.e., towards the opening and towards the back wall). During a cutting operation, the hole saw 34 can be advanced, as far as needed, towards the surface of the pipeline. After the cutting operation is complete, the hole saw 34 can be moved radially outwards towards the back wall 26 of the receptacle 20. Shaft 38 attached to the hole saw 34 can control this proximal to distal movement, as well as the rotational movement of the hole saw 34.

The shaft 38 can be slidably disposed through an opening 36 in the receptacle, such as an opening in the back wall 26. The opening 36 can include a fluidic seal 39 that maintains fluid within the receptacle 20 while still allowing rotation of the shaft 38 with minimal friction. Exemplary fluidic seals are made from fluoroelastomers (e.g., Viton™ polymers) or nitrile-based polymers. The opening 36 can also include a rotation facilitating member 41 comprising bearings that facilitates movement of the shaft. The bearings can be located in a housing 61 that surrounds a portion of shaft 38. In some embodiments, the rotation facilitating member 41 includes a plurality of bearings. The bearings can have a cylindrical shape having rotational axes that are parallel with the rotational axis CA of the shaft. Within the opening, the fluidic seal 39 can be disposed distally to the rotation facilitating member 41, that is, closer to the opening in the receptacle.

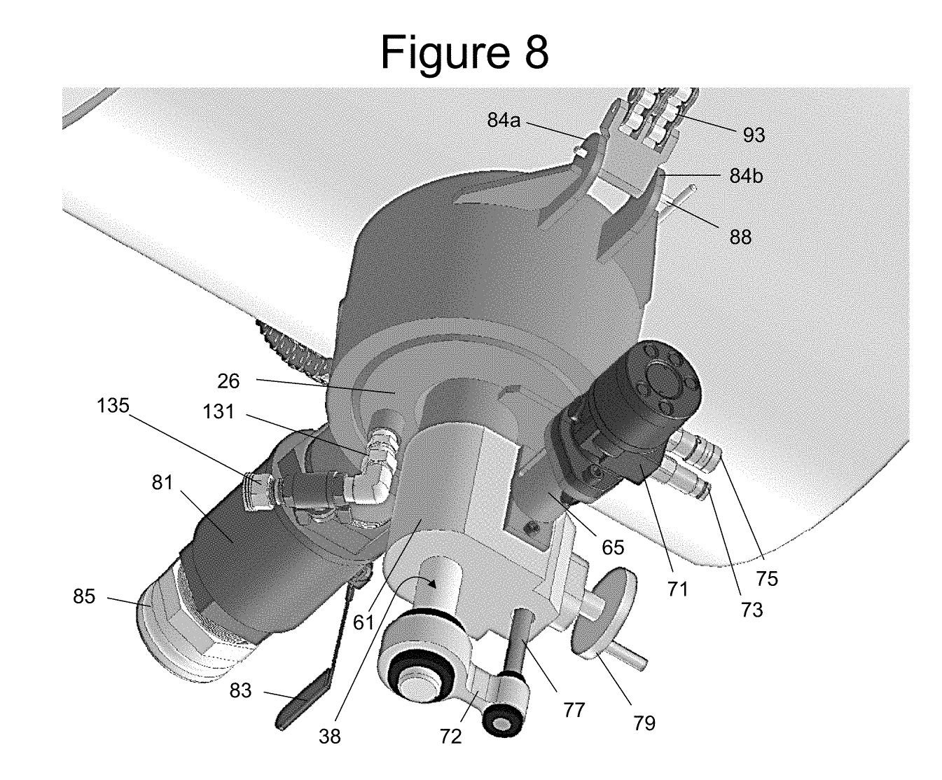

Referring back to FIG. 2, the apparatus can further include a housing 61 that facilitates movement of the shaft 38. The housing 61 can include one or more gears, and at least one gear therein can engage a portion of the shaft 38 to cause rotational movement of the shaft 38. The housing 61 can also stabilize the shaft 38 along at least a portion of its length so that during the cutting operation the hole saw cuts a precise hole in the wall of the pipeline. FIG. 8 is a perspective view of the apparatus showing the housing 61, and a distal portion of the shaft 38 that is exterior to the housing. Therefore, a portion the shaft 38 can be disposed and movable within the receptacle, a portion disposed and movable within the housing, and a portion external to the housing that is movable.

The pipe cutting/fluid removal apparatus can also be described with regards to its height (H₁), which refers to the distance between the end of the shaft 38 (i.e., the end that is exterior to the housing 61) and the rim of the receptacle 43. In exemplary embodiments H₁ is in the range of about 10 inches to 48 inches, about 15 inches to about 36 inches, or about 18 inches to about 30 inches.

The apparatus can further include a mechanism to drive rotation of the shaft, which in turn drives rotation of the hole saw. Rotation of the shaft can be driven manually, such as by an arm and handle that is attached directly to the shaft, or indirectly, such as through one or more gears in a mechanical arrangement between the shaft and the arm and handle. Preferably, rotation of the shaft is driven by a motor, such as a high torque, low RPM, hydraulic motor, or an air motor. FIGS. 3 and 8 show a hydraulic motor 71 indirectly attached to the housing 61 through a shaft coupling assembly 65, which can provide rotation of the shaft. The hydraulic motor 71 can include input port 73 and outlet port 75 for hydraulic fluid entering and exiting the hydraulic motor. Hydraulic lines (not shown) can be connected to input port 73 and outlet port 75 which in turn can be connected to a hydraulic power supply (not shown) that provides pressurized hydraulic fluid to the hydraulic motor 71. Alternatively, the hydraulic system can be replaced with an air system to provide movement of the shaft.

In other arrangements, the motor that provides rotation of the shaft may be mounted on another part of the apparatus, such as the back wall of the receptacle. In embodiments, movement of the shaft (i.e., rotational and proximal and distal) is carried out by non-electric means.

The shaft can include one or more grooves or notches (not shown) along at least a portion of its length at the proximal end of the shaft which can engage a gear (not shown) of the motor. The shaft can engage the gear along a portion of its length so the shaft can be rotated as it moves in a distal or proximal direction.

The apparatus can also include a mechanism that provides movement of the shaft in proximal and distal directions. In one embodiment, the (first) shaft 38 coupled to the hole saw 34 is mechanically coupled to a second shaft 77 that is movable to affect proximal to distal movement of the first shaft 38. As shown in FIG. 8, the axis of the second shaft 77 can be parallel to the axis of the first shaft 38. A coupling member 72 can couple the first shaft 38 to the second shaft 77, so that when the second shaft 77 is moved in a distal or proximal direction, the first shaft 38 is moved correspondingly.

The second shaft 77 can also include one or more grooves or notches (not shown) along at least a portion of it length. The notches or grooves can engage a gear which can be operated to affect movement of the second shaft 77. Movement of the second shaft 77 can be carried out using a manually operated mechanism, such as a handle or wheel 79 mechanically coupled to a gear (not shown) affecting movement of the shaft. Depending on the direction, rotation of the wheel 79 can cause movement of the second shaft 77 in a proximal or a distal direction, which in turn causes movement of the first shaft 38 and the hole saw 34. Alternatively, movement of the second shaft 77 can be accomplished by other means, such as by a motor attached to a gear, or by a hydraulic system that directly affects movement of the second shaft 77.

Referring back to FIG. 2, the apparatus also includes a port 28 that allows fluid to exit the receptacle 20. The port 28 can include an opening in any portion of the receptacle wall, such as the side wall 24b as shown in FIG. 2. The port 28 can be of any shape and size, but preferably the size is about the same size or greater, such as about 0.5% to about 50%, about 0.5% to about 25%, or about 1% to about 10% greater than the size of hole that is bored in the pipeline using the hole saw. For example, the exit port can have an opening the size in the range of about 1 in² to about 30 in², or about 3.5 in² to about 20 in².

The apparatus can also include within the receptacle a grate 32 or filter over the opening of the port 28. The grate 32 can prevent objects that may become present in fluid within the receptacle 20, such as a piece of the pipeline that is cut using the hole saw 34, from entering the flow of fluid away from the receptacle 20, which may otherwise clog the tube that carries fluid away from the receptacle 20.

The port 28 can lead into a conduit 30 extending from the outer surface of the wall of the receptacle 20, such as a conduit in the form of a portion of a pipe extending from the side wall as shown in FIG. 2. The conduit 30 can have a smaller diameter than the diameter of the receptacle 20. Also with reference to FIGS. 2 and 8, the conduit can have a distal end configured for attachment to a valve 81. The distal end of the conduit 30 can have external threads or another suitable feature for attachment of the valve 81. The valve can be actuated with a handle 83 to open and close an internal valve component, such as a ball, that can restrict movement of fluid through the valve 81. The distal portion of the valve 81 can have a coupling member 85, such as a camlock coupling, for attachment of a tube that can carry fluid away from the receptacle 20.

Optionally, another conduit (e.g., a second conduit that is different than conduit 30) can be attached to the wall of the receptacle. For example, referring to FIG. 8, the apparatus can include conduit 131, which is attached to the back wall 26 of the receptacle. The conduit 131 can be in fluid connection with the inner portion of the receptacle through an opening (e.g., a fourth opening, not shown) in the back wall 26. This (fourth) opening can be smaller than, or about the same size as the (third) opening through which the shaft 38 is disposed. The conduit can be of any desired length or shape. As shown in FIG. 8, the conduit 131 has an “L” shape with a first proximal portion parallel to the axis of the shaft 38, and a second distal portion perpendicular to the shaft, that extends away from the axis. The conduit can include a coupling member 135 for attachment of a tube or line. The second conduit can be used as a fluid conduit, such as an additional route for fluid to exit the receptacle.

The receptacle 20 can include one or more features that facilitate its mounting on the external surface of a pipeline. For example, at one or more locations on the outer surface of the receptacle are mounting apparatus engagement member(s). The engagement members facilitate portions of mounting apparatus to be attached to the receptacle. The mounting apparatus is used to force the receptacle up against the pipeline during a fluid removal process. The attachment members can include tabs, extensions, loops, eyelets, etc., that are attached to or formed on the exterior wall of the receptacle, such as by welding, using screws, etc. In one arrangement as shown in FIG. 2, the apparatus includes first 84 and second 86 attachment members that are attached to and opposite one another on the exterior surface of receptacle 20.

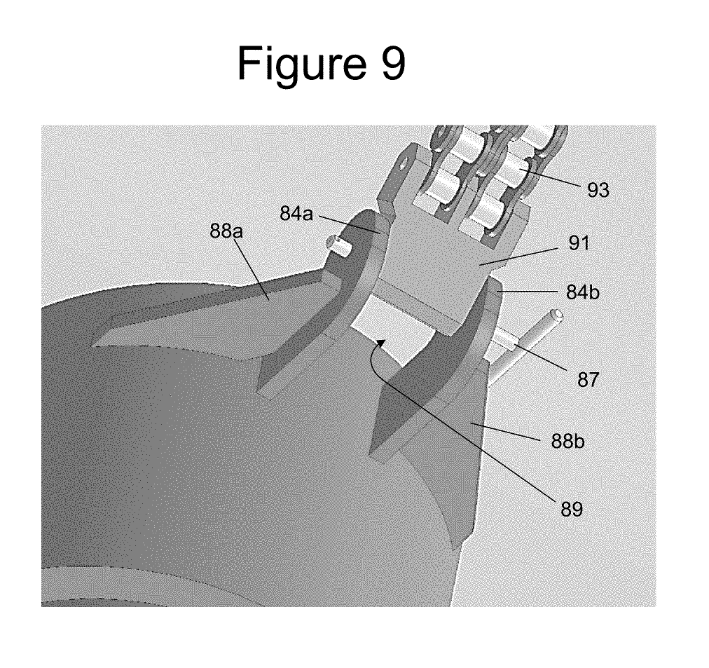

FIGS. 8 and 9 show embodiments of the attachment member in greater detail. Each attachment member includes a pair of tabs (84a, 84b) that are parallel to one another and that extend from the outer surface of the receptacle 20. In particular, tabs 84a and 84b can be attached to a portion of the receptacle wall that is of greater height (i.e., wall portions 24a and 24b, see also FIG. 5 H₂>H₃) and proximal to (e.g., adjacent to) the rim 43 of the receptacle (see FIG. 4). The proximal portion of the tabs 84a and 84b can be welded to the outer surface of receptacle and each tab can be structurally stabilized by a flange (88a, 88b) that has a side welded to the outer surface of the tab (84a, 84b), and a curved side welded to the outer surface of the receptacle.

The tabs (84a, 84b) can be arranged to provide a gap 89 between their inner surfaces. The gap 89 can be configured to accommodate and attach to a link 91 at the distal end of one extension member 93 (e.g., a chain) of the mounting apparatus. For example, the tabs 84a and 84b (at their outer ends) and the link 91 can include openings through which a securing pin 87 can be placed so the receptacle 20 of the apparatus can be attached to the mounting apparatus 14 (see FIG. 1). This can allow the link 91 to swivel relative to the tabs 84a and 84b.

Referring back to FIG. 1, the mounting apparatus 14 can include one or more elongate member(s) 93 having an end that can attach to one pair of tabs of the receptacle. In some embodiments, and referring to FIG. 2, the mounting apparatus has two elongate members, a first elongate member 93 having an end that can attach a first pair of tabs (84a and 84b), and a second elongate member 95 having an end that can attach to a second pair of tabs (86a and 86b). The ends of the elongate members are first and second links that attach to the pairs of tabs arranged on opposite sides of the receptacle.

Elongate member can be bendable or flexible in at least one direction. This will allow the elongate member to bend around a least a portion of an outer surface of the pipe. Exemplary elongate members include cables, chains, bands, and straps. The elongate member can include notches or openings, which can engage a portion of the length-adjustment member. The elongate member can be made from a metal or a polymeric material, or combinations thereof. In preferred embodiments and with reference to FIG. 9 the elongate member 93 comprises chain links.

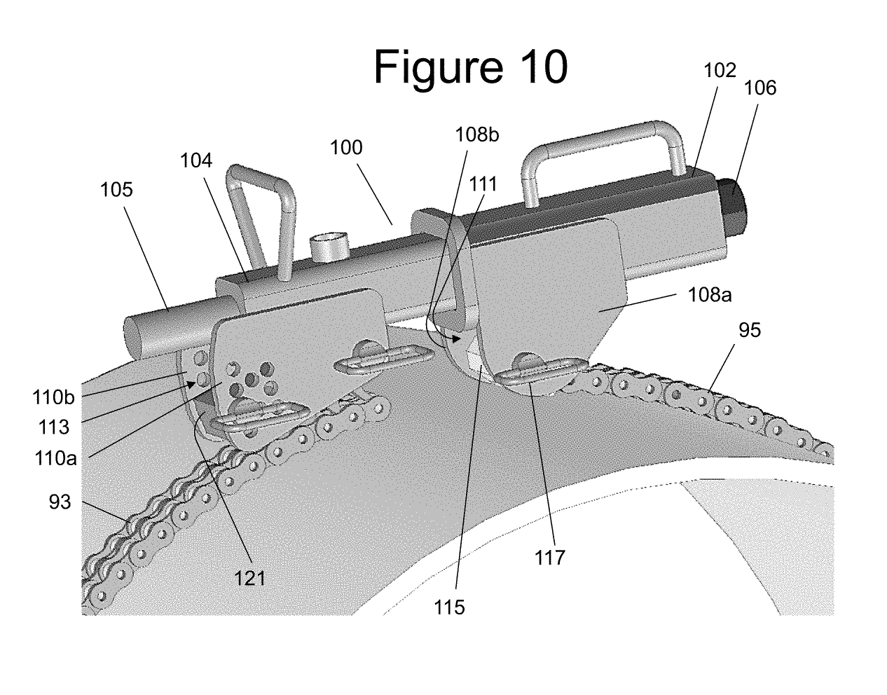

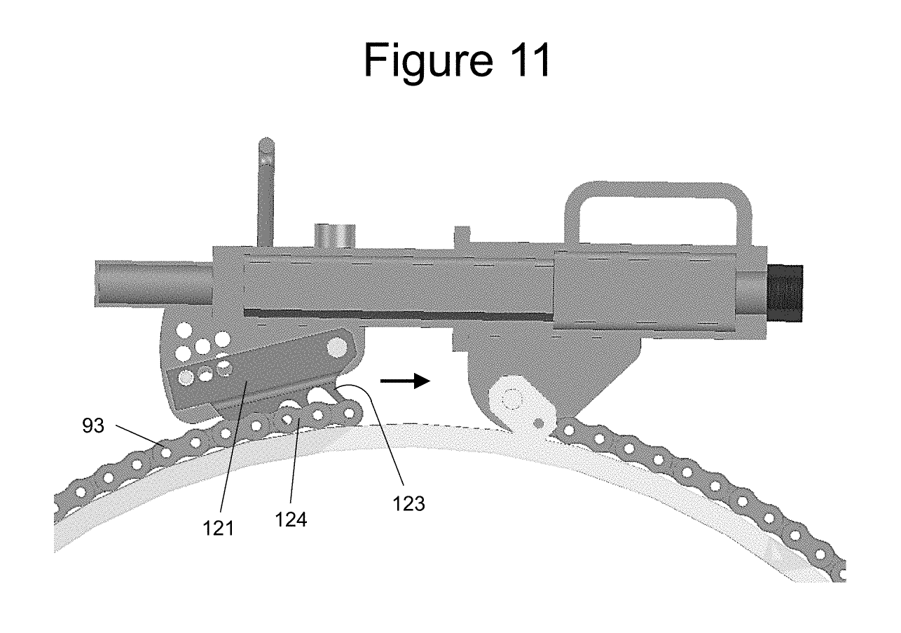

Referring to FIG. 10, the mounting apparatus can also include a connecting member 100 that can attach to the one or more elongate member(s) (e.g., 93 and 95). Adjustment of the connecting member 100 can force the elongate member 93 and 95 closer together which in turn allows the pipeline-facing rim of the fluid removal apparatus 20 to be pressed up against and form a fluidic seal with the outer surface of the pipeline (see FIG. 2). In one embodiment, the mounting apparatus includes first elongate member 93 and second elongate member 95 formed of chain links and the length-adjustment connecting member 100 is attached to the chain links.

The connecting member 100 can have an elongate shape with first section 102, second section 104, and a threaded rod 105 disposed and extending through the first 102 and second 104 sections. At least a proximal portion of second section 104 is slidably movable within a distal portion of the first section 102. Movement of the second section 104 in relation to the first section 102 can be carried out by rotation of the threaded rod 105. The threaded rod 105 can include shaped head 106 at its distal end which can be rotated with use of a tool.

The first section 102 and second section 104 can include attachment members that can connect the connecting member 100 to the first elongate member 93 and second elongate member 95. In an exemplary embodiment, the attachment members include a first pair of tabs 108a and 108b attached to (e.g., welded) and extending from the lateral surfaces of the first section 102, and a second pair of tabs 110a and 110b attached to (e.g., welded) and extending from the lateral surfaces of the second section 102. In a working arrangement, the first and second sets of tabs extend downwards towards the pipeline surface.

The tabs (108a and 108b, 110a and 110b) can be arranged to provide gaps 111 and 113, respectively, between their inner surfaces. The gap 111 can be configured to accommodate and attach to a link 115 at the proximal end of extension member 95. The tabs 108a and 108b and the link 115 can include openings through which a securing pin 117 can be placed. This can secure the connecting member 100 to the extension member 95.

Gap 113 can be configured to accommodate and attach an extension engagement member 121. Extension engagement member 121 can include one or more teeth 123 with end(s) biased towards the first section 102 of the connecting member 100, wherein the teeth can fit within an opening in a chain link 124. In a working arrangement, the chain of the connecting member is positioned between the surface of the pipeline and the extension engagement member 121 with teeth, which engage the links of the extension member 93. When the threaded rod 105 is turned to move the second section 104 into the first section 102, this, in turn, applies force to the links via the teeth to move the extension member 93 in the direction of the arrow.

The apparatus can be used for the removing fluid from a pipeline, including above-ground pipelines and below-ground pipelines. In some methods, the fluid removal is performed prior to repair or replacement of a section of the pipeline. It is typically desired to remove all or substantially all of the fluid in the pipeline, which can be oil or a petroleum product, prior to the repair or replacement of the pipeline section to avoid loss of the fluid to the surrounding area.

If fluid is to be removed from a below-ground pipeline, ground surrounding the pipeline is typically excavated, including ground underneath the pipeline. An amount of ground underneath the section of the pipeline from which fluid is intended to be removed is excavated to provide room for placement of the pipe cutting/fluid removal apparatus 12. The excavated ground underneath the pipeline can be less than about 5 feet, less than about 4½ feet, less than about 4 feet, less than about 3½ feet, less than about 3 feet, less than about 2½ feet, depending on the size of the pipeline fluid is removed from and the overall size of pipeline and the size of the cutting/fluid removal apparatus to be used. Generally, it is desirable to have at least about two feet of excavated ground underneath the pipeline. Also see FIG. 2.

In a fluid removal method the pipe cutting/fluid removal apparatus 12 can be positioned beneath a section of pipeline from which fluid is desired to be removed. First 93 and second 95 elongate members can be attached to the receptacle 20 of the pipe cutting/fluid removal apparatus 12. The first 93 and second 95 elongate members can then be brought up around each side of the pipeline to the top of the pipeline. The second 95 elongate member can be pre-attached to the connecting member 100, or connecting member 100 can be attached to the second elongate member 95 after it is brought to the top of the pipeline. Teeth 123 of the extension engagement member 121 can be engaged in the openings of the links at the end of the first extension member 93.

At this point, the pipe-facing portion of the receptacle 20 may be close to, or in contact with, the surface of the pipeline. However, the apparatus at this point may be loosely associated with the pipeline, with a certain amount of slack remaining in the extension members resulting in the receptacle not being firmly pressed up against the pipeline. In this loose but mounted arrangement, the position of the pipe cutting/fluid removal apparatus 12 and the entire mounting apparatus 14 can be rotationally adjusted to place the pipe-facing opening of the receptacle 20 in the desired position on the pipeline. After the pipe cutting/fluid removal apparatus 12 is placed in a desired position, the threaded rod 105 of the connecting member 100 can be turned to increase the tension on the first 93 and second 95 elongate members which tightens the entire assembly around the pipeline. In turn, this forces the receptacle 20 up against the surface of the pipeline, compressing the gasket 55 within the recess 45 of the rim 43. This forms a fluidically tight seal between the receptacle 20 and the outer surface of the pipeline. Accordingly, fluid entering the receptacle from the pipeline will not be lost when fluid removal is performed.

In some modes of practice, the seal can be tested prior to the fluid removal process. For example, the receptacle can be pressurized though conduit 131 and monitored for any leaks around the gasket.

Optionally, another conduit (e.g., a second conduit that is different than conduit 30) attached to the wall of the receptacle. For example, referring to FIG. 8, the apparatus can include conduit 131, which is attached to the back wall 26 of the receptacle. The conduit 131 can be in fluid connection with the inner portion of the receptacle through an opening (e.g., a fourth opening, not shown) in the back wall 26. This (fourth) opening can be smaller than, or about the same size as the (third) opening. The conduit can be of any desired length or shape. As shown in FIG. 8, the conduit 131 has an “L” shape with a first proximal portion parallel to the axis of the shaft 38, and a second distal portion perpendicular to the shaft, that extends away from the axis. The conduit can include a coupling member 135 for attachment of a tube or line. The second conduit can be used as an additional route for fluid to exit the receptacle.

Prior to starting the cutting procedure, the coupling member 85 of valve 81 can be connected to a fluid removal conduit, such as a large diameter flexible tube (not shown). Preferably the fluid removal conduit tube has a diameter about the same size as the diameter of conduit 30. The fluid removal conduit can be fluidically connected to a pump which can generate low pressure to pull fluid through the conduits and receptacle of the pipe cutting/fluid removal apparatus from within the pipeline. Also, hydraulic lines (not shown) can be connected to input port 73 and outlet port 75 which in turn can be connected to a hydraulic power supply (not shown) that provides pressurized hydraulic fluid to the hydraulic motor 71.

The cutting process can begin by actuating the hydraulic motor 71 which in turn rotates the shaft 38 and the attached hole saw 34. Alternatively, an air motor is used. After the motor is actuated, the hole saw can be advanced towards the pipeline surface by rotating wheel 79. The cutting edge of the hole saw enters through the material of the pipeline. To liberate particles of cut pipe material from the cutting edge interface, during the cutting process the hole saw can be advanced into the material of the pipeline and retracted prior to making a full cut through the pipeline material, and then advanced again. Advancing/retraction can be performed as desired.

With reference to FIG. 2, after the hole is cut into the pipeline, a circular cut-out portion of the pipeline may become lodged in the hole saw 34. Such a cut-out can be removed after the cutting operation is complete. In some instances, the cut-out portion may become dislodged in the receptacle 20. In these situations, the grate 32 in front of the port 28 can prevent the cut-out portion from moving into the port and the conduits leading away from the receptacle.

After the hole is cut in the pipeline wall, fluid, such as oil or a petroleum product, can enter the receptacle. With the pipe cutting/fluid removal apparatus 12 being positioned beneath the fluid in the pipeline, fluid can flow into the receptacle by gravity. If the pipeline is located at an elevation that is greater than a location the fluid is desired to be moved to (e.g., a storage tank), movement of all the fluid can be carried out by gravity. However, in preferred modes of practice, a pump is used to pull fluid from the pipeline, through the receptacle and conduits, and to another location, such as a tank.

After the fluid removal operation is complete, the pipe cutting/fluid removal apparatus 12 can be removed from the pipeline, such as by rotating the threaded rod 105 of the connecting member 100 to decrease the tension on the first 93 and second 95 elongate members. The extension engagement member 121 with teeth can be disengaged from the links of the extension member 93. The apparatus can then be removed from the pipeline.

What is claimed is:

1. An apparatus for removing fluid from a pipeline configured to be temporarily placed on an external surface the pipeline, the apparatus comprising
a receptacle member configured to accommodate fluid obtained through a hole made in a pipeline, and configured to allow the fluid out of the receptacle, the receptacle comprising:
at least one wall defining the receptacle member,
a first opening on a pipeline-facing portion of the receptacle member,
a rim defining the first opening, wherein the rim has a shape that conforms to an outer surface of a pipeline that forms a fluidically tight seal with the surface of the pipeline when the receptacle is forced up against the pipeline,
a second opening through the at least one wall configured to allow fluid
out of the receptacle, and
a third opening in a wall of the receptacle;
a drill or saw disposed within the receptacle member which is rotatable to cause cutting of a pipeline, and radially movable towards and away from the pipeline wall;
a shaft attached to the drill or saw that is rotatable and slidably movable in a radial direction and disposed within the third opening,
wherein the first opening is larger than the second or third opening, and
wherein the apparatus is configured to be forced up against an external surface of the pipeline.

2. The apparatus of claim 1 wherein the receptacle comprises a side wall and a back wall.

3. The apparatus of claim 2 wherein the side wall has a circular or oval shape.

4. The apparatus of claim 2 wherein the back wall comprises the third opening.

5. The apparatus of claim 1 wherein the second opening is larger than the third opening.

6. The apparatus of any of claim 1 wherein the rim comprises a gasket in a recess of the rim.

7. The apparatus of claim 1 comprising one or more attachment member(s) on an external surface of the wall, wherein the attachment member is configured for attachment of a pipeline circumferential securing device configured to force the receptacle up against an external surface of the pipeline.

8. The apparatus of claim 1 comprising a fluidic seal between shaft and the third opening.

9. The apparatus of claim 1 wherein the drill or saw is a hole saw.

10. The apparatus of claim 1 a hydraulic motor or an air motor that drives rotation of the shaft.

11. The apparatus of claim 1 comprising a second shaft that is parallel and coupled to the first shaft, wherein the second shaft can be moved in a radial direction to affect movement of the shaft attached to the drill or saw.

12. The apparatus of claim 11 wherein the second shaft is mechanically coupled to one or more gears and a wheel that can be rotated to cause radial movement of the second shaft.

13. The apparatus of claim 1 wherein the receptacle can accommodate a fluid volume in the range of about 100 in³ (˜1.64 L) to about 2500 in³ (˜41 L).

14. The apparatus of claim 1 wherein the second opening is attached to a conduit that comprises a valve that can regulate flow of fluid out of the receptacle.

15. An assembly kit for removing fluid from a pipeline comprising the cutting and fluid removal apparatus of claims 1, one or more elongate members that can be attached to the cutting and fluid removal apparatus and that can extend partially or fully around the circumference of a pipeline, and a connecting member attachable to the one or more elongate members which can be actuated to affect movement of the one or more elongate members and force the cutting and fluid removal apparatus up against the outer surface of a pipeline.

16. The assembly kit of claim 15 comprising a first elongate member having a first end attached to a first attachment member on the outer surface of the receptacle, a second elongate member having a first end attached to a second attachment member on the outer surface of the receptacle, wherein the first and second attachment member are on opposite sides of the wall of the receptacle.

17. The assembly kit of claim 15 wherein the elongate member comprises chain links.

18. The assembly kit of any one of claim 16 wherein the first elongate member has a second end that is attached to a first part of the connecting member, and the second elongate member has a second end that is attached to a second part of the connecting member, and the first and second parts of the connecting member are movable in relation to one another.

19. The assembly kit of claim 18 wherein (a) the first part of the connecting member comprises a plurality of teeth configured to engage openings in chain links at the second end of the first elongate member, (b) the connecting member comprises a threaded rod that can be rotated to cause movement of the first part and second part in relation to one another, or both (a) and (b).

20. A method for removing fluid from a pipeline comprising:
providing an apparatus for removing fluid from a pipeline comprising a receptacle member defined by at least one wall, the receptacle comprising a first opening that conforms to an outer surface of a pipeline, a second opening in the at least one wall that allows fluid to exit the receptacle, and a drill or saw attached to a shaft movable through a third opening in the at least one wall;
placing the first opening up against the surface of a pipeline to form a fluidically tight seal;
moving the shaft and attached saw or drill in a radial direction towards the pipeline;
cutting a hole in the pipeline by rotating the shaft and attached saw or drill; and
removing fluid from the pipeline through the receptacle and second opening.
